(19) United States
(12) Patent Application Publication
(10) Pub. No.: US 2023/0368236 A1
(43) Pub. Date: Nov. 16, 2023

(54) TREATMENT LIFT SCORE AGGREGATION FOR NEW TREATMENT TYPES

(71) Applicant: Maplebear Inc. (dba Instacart), San Francisco, CA (US)

(72) Inventors: Tilman Drerup, Palo Alto, CA (US); Anne Moxie, Yorktown Heights, NY (US); Sophia Li, San Francisco, CA (US); Vibin Kundukulam, Seattle, WA (US); Jonathan Gu, San Francisco, CA (US); Ashley Denney, Albany, CA (US)

(21) Appl. No.: 17/744,526

(22) Filed: May 13, 2022

(51) Int. Cl. G06Q 30/02; G06Q 30/06

(52) U.S. Cl. CPC G06Q 30/0211; G06Q 30/0239; G06Q 30/0617

(57) ABSTRACT

An online concierge system uses a new treatment engine to score users for applying treatments of a new treatment type. The new treatment engine uses treatment models to generate treatment lift scores for the user. The new treatment engine applies an aggregation function model to the treatment lift scores to generate an aggregated lift score for the user. If the aggregated lift score exceeds a threshold, the new treatment engine applies a treatment of the new treatment type to the user. The new treatment engine trains the aggregation function model based on training examples used to train the treatment models. For a training example associated with a particular treatment type, the new treatment engine uses a target lift score generated by the treatment model for the treatment type to evaluate the performance of the aggregation function model, and to update the aggregation function model accordingly.

### BACKGROUND

Online systems, such as online concierge systems, often apply treatments to users to encourage those users to interact with the online system. For example, an online system may notify a user of new content that is available to the user or may provide incentives to a user if the user performs an interaction with the online system.

In some instances, online systems may apply different treatments to different users. Online systems sometimes use machine learning models that are trained to select which treatment to apply to a particular user. However, for new types of treatments, the online system may lack sufficient training data to train a machine-learning model to accurately select when to apply the new treatment type to a user. Thus, there may be a period of time, as training data is collected, during which the online system may ineffectively select a treatment of a new treatment type.

### SUMMARY

In accordance with one or more aspects of the disclosure, an online concierge system may use a new treatment engine to determine when to apply a treatment of a new treatment type to a user. To determine whether to apply a new treatment type to a user, the online concierge system may access a set of treatment models that generate treatment lift scores for treatments of different treatment types. The online concierge system may receive user data describing characteristics of a user, and may apply the set of treatment models to the user data to generate treatment lift scores for the user. A treatment lift score generated by a treatment model is a score representing an increase in likelihood that the user will interact with the online concierge system as a result of applying a treatment of the treatment type associated with the treatment model. The online concierge system may apply an aggregation function model to the generated treatment lift scores to generate an aggregated lift score for a user. The online concierge system may use the aggregated lift score to determine whether to apply the new treatment type to the user by determining whether the aggregated lift score exceeds a threshold. If the aggregated lift score exceeds the threshold, the online concierge system may apply a treatment of the new treatment type to the user.

The online concierge system may train the aggregation function model based on training examples for treatment models. The online concierge system may access a set of treatment models that each correspond to a treatment type of a set of treatment types. For each treatment type in the set of treatment types, the online concierge system identifies a training example associated with the treatment type. The online concierge system also selects a subset of treatment models, wherein the subset does not include the treatment model that corresponds to the treatment type of the training example. The online concierge system generates treatment lift scores by applying the treatment models in the subset to user data in the training example, and generates an aggregated lift score for the training example by applying the aggregation function model to the treatment lift scores. The online concierge system generates a target lift score by applying the treatment model associated with the treatment type of the training example to the user data of the training example. The online concierge system compares the target lift score to the aggregated lift score, and updates the aggregation function model based on a difference between the scores.

The aggregation function model allows the online concierge system to use pre-trained machine-learning models for new treatment types. If the set of treatment models is selected such that the treatment types associated with the set of treatment models are similar to the new treatment type, the aggregation function model may generate aggregated lift scores that perform well with minimal training data. Thus, by implementing one or more aspects of the disclosure, an online concierge system may improve on the cold-start problem that conventional online systems face when presented with relatively low amounts of training data.

### BRIEF DESCRIPTION OF DRAWINGS

FIG. 1 illustrates the environment of an online concierge system, according to some embodiments.

FIG. 2 is a block diagram of an online concierge system, according to some embodiments.

FIG. 3A is a block diagram of the customer mobile application (CMA), according to some embodiments.

FIG. 3B is a block diagram of the picker mobile application (PMA), according to some embodiments.

FIG. 3C is a block diagram of the runner mobile application (RMA), according to some embodiments.

FIG. 4 illustrates a data flow through an example new treatment engine, in accordance with some embodiments.

FIG. 5 illustrates a data flow through an example new treatment engine during a training process, in accordance with some embodiments.

FIG. 6 is a flowchart illustrating a method for generating aggregated lift scores for a new treatment to be applied to a user, in accordance with some embodiments.

FIG. 7 is a flowchart illustrating a method for training an aggregation function model, in accordance with some embodiments.

### DETAILED DESCRIPTION

### Environment of an Online Concierge System

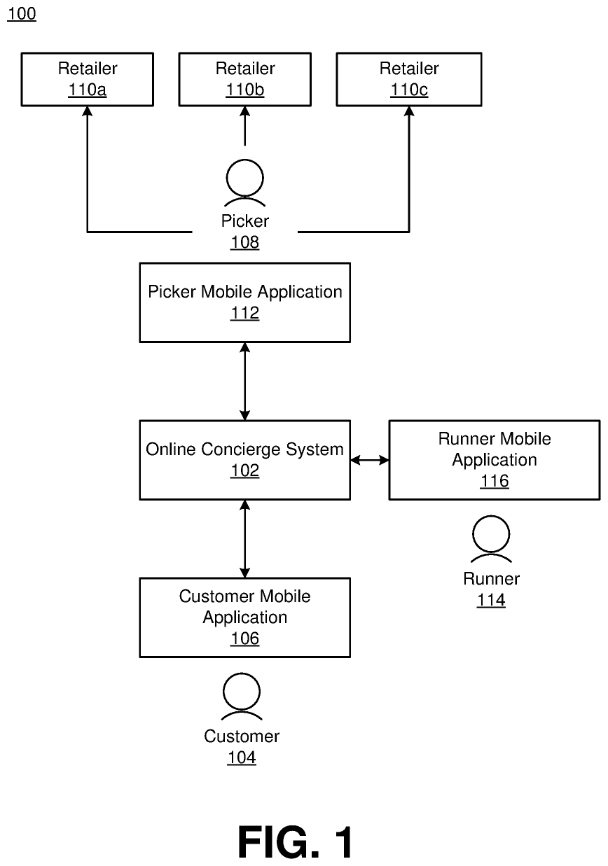

FIG. 1 illustrates an example system environment 100 of an online concierge system 102, according to some embodiments. The system environment 100 illustrated in FIG. 1 includes an online concierge system 120, a customer 104, a customer mobile application 106, a picker 108, one or more retailers 110, a picker mobile application 112, a runner 114 and a runner mobile application 116. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Additionally, the figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The online concierge system 102 is configured to receive orders from one or more customers 104 (only one is shown for the sake of simplicity). An order specifies a list of goods or products to be delivered to the customer 104. Goods, items, and products may be used synonymously herein to mean any item that a customer 104 can purchase via the online concierge system. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more pickers 108. A picker 108 may be a contractor, employee, or other person (or entity) who is enabled to fulfill orders received by the online concierge system 102. The environment 100 also includes three retailers 110a, 110b, and 110c (only three are shown for the sake of simplicity; the environment could include any number of retailers). The retailers 110 may be physical retailers, such as grocery stores, discount stores, department stores, etc., or non-public warehouses storing items that can be collected and delivered to customers. Each picker 108 fulfills an order received from the online concierge system 102 at one or more retailers 110, delivers the order to the customer 104, or performs both fulfillment and delivery. In some embodiments, pickers 108 make use of a picker mobile application 112 which is configured to interact with the online concierge system 102. In some embodiments, a picker 108 may also be a runner 114 or vice versa. Additionally, customers 104, pickers 108, or runners 114 may be referred to generically as “users” of the online concierge system 102.

### Online Concierge System

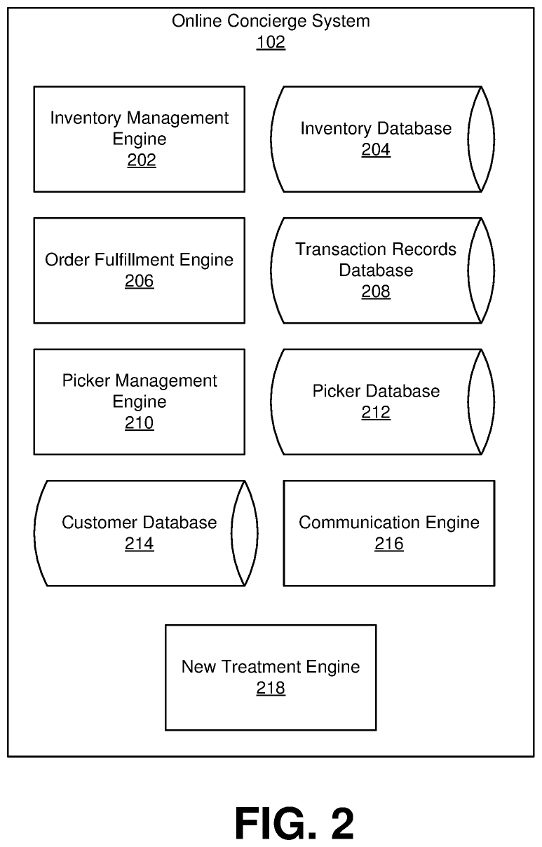

FIG. 2 is a block diagram of an online concierge system 102, according to some embodiments. The online concierge system illustrated in FIG. 2 includes an inventory management engine 202, an inventory database 204, an order fulfillment engine 206, a transaction records database 208, a picker management engine 210, a picker database 212, a customer database 214, a communications engine 216, and a new treatment engine 218. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The online concierge system 102 includes an inventory management engine 202, which interacts with inventory systems associated with each retailer 110. In some embodiments, the inventory management engine 202 requests and receives inventory information maintained by the retailer 110. The inventory of each retailer 110 is unique and may change over time. The inventory management engine 202 monitors changes in inventory for each participating retailer 110. The inventory management engine 202 is also configured to store inventory records in an inventory database 204. The inventory database 204 may store information in separate records—one for each participating retailer 110—or may consolidate or combine inventory information into a unified record. Inventory information includes both qualitative and quantitative information about items, including size, color, weight, SKU, serial number, and so on. In some embodiments, the inventory database 204 also stores purchasing rules associated with each item, if they exist. For example, age-restricted items such as alcohol and tobacco are flagged accordingly in the inventory database 204.

In some embodiments, the inventory database 204 stores product embeddings for products offered for sale on the online concierge system 102. A product embedding is an embedding that describes a product. The product embeddings may be associated with specific products stored by the inventory database 204. For example, each brand of a product may have an individual product embedding, or products may have different product embeddings for each retailer that sells the product. Alternatively, each product embedding may be associated with a generic product, and each generic product is associated with specific products that are similar or substitutes of each other. For example, the inventory database 102 may store a product embedding for the generic product “milk”, and the specific products of “Moo Moo 2% Milk” and “Greener Pastures Organic Whole Milk” may both be associated with the product embedding for “milk.”

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which retailers 110. The order fulfillment engine 206 determines a sale price for each item ordered by a customer 104. Prices set by the order fulfillment engine 206 may or may not be identical to in-store prices determined by retailers (which is the price that customers 104 and pickers 108 would pay at retailers). The order fulfillment engine 206 also facilitates transactions associated with each order. In some embodiments, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with retailer 110. For example, after successful fulfillment of an order, the order fulfillment engine 206 may transmit a summary of the order to the appropriate retailer. The summary may indicate the items purchased, the total value of the items, and in some cases, an identity of the picker 108 and customer 104 associated with the transaction. In some embodiments, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a picker management engine 210, which manages communication with and utilization of pickers 108. In some embodiments, the picker management engine 210 receives a new order from the order fulfillment engine 206. The picker management engine 210 identifies the appropriate retailer 110 to fulfill the order based on one or more parameters, such as the contents of the order, the inventory of the retailers, and the proximity to the delivery location. The picker management engine 210 then identifies one or more appropriate pickers 108 to fulfill the order based on one or more parameters, such as the pickers' proximity to the appropriate retailer 110 (and/or to the customer 104), his/her familiarity level with that particular retailer 110, and so on. Additionally, the picker management engine 210 accesses a picker database 212 which stores information describing each picker 108, such as his/her name, rating, previous shopping history, and so on. The picker management engine 210 transmits the list of items in the order to the picker 108 via the picker mobile application 112. The picker database 212 may also store data describing the sequence in which the pickers' picked the items in their assigned orders.

As part of fulfilling an order, the order fulfillment engine 206 and/or picker management engine 210 may access a customer database 214 which stores information describing each customer. This information could include each customer's name, address, gender, shopping preferences, favorite items, stored payment instruments, and so on.

The online concierge system 102 may use a communication engine 216 that transmits information between the customer mobile application 106, the picker mobile application 112, and the runner mobile application 116. The information may be sent in the form of messages, such as texts or emails, or notifications via application, among other forms of communication. The communication engine 216 may receive information from each application about the status of an order, the location of a customer in transit, issues with items in an order, and the like. The communication engine 216 determines a message or notification to send to a customer 104, picker 108, or runner 114 based on this information and transmits the notifications to the appropriate application. For example, the online concierge system 102 may receive information from the customer mobile application 106 indicating that a customer 104 is traveling to the pickup location to retrieve an order. Based on this information, the communication engine 216 sends a notification to the runner mobile application 116 indicating that the customer 104 associated with a specific order is in transit, which may incite the runner 114 to retrieve the order for pick up. In another example, the online concierge system 102 may receive a message from the picker mobile application 112 that an item of an order is not available. The communication engine 216 may transmit the message to the customer mobile application 106 associated with the order.

The online concierge system 102 includes a new treatment engine 218. The new treatment engine 218 uses treatment models that are trained to generate treatment lift scores for different treatment types to score users for a new treatment type for which the online concierge system 102 may have insufficient training data. The new training engine 218 is discussed in further detail below.

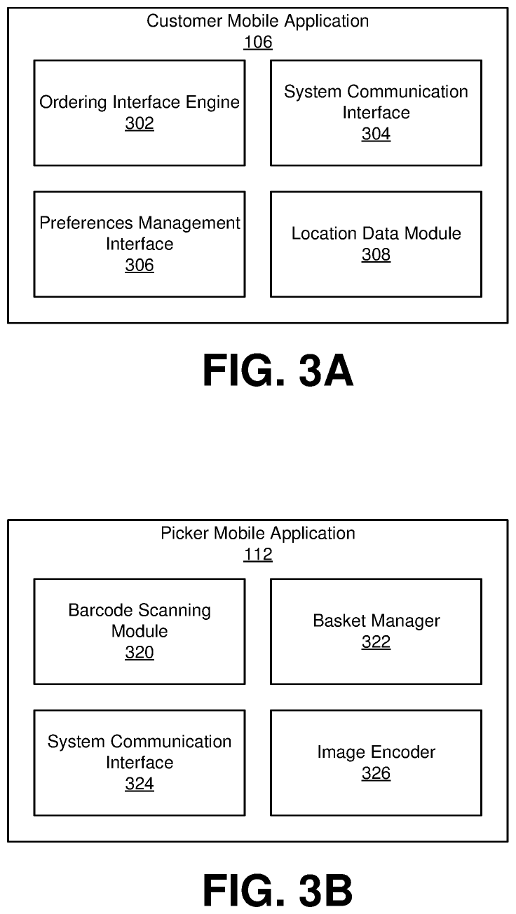

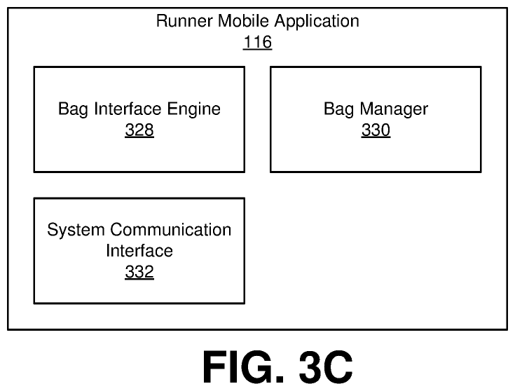

FIG. 3A is a block diagram of the customer mobile application (CMA) 106, according to some embodiments. The CMA 106 illustrated in FIG. 3A includes an ordering interface engine 302, a system communication interface 304, a preferences management interface 306, and a location data module 308. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The customer 104 accesses the CMA 106 via a client device, such as a mobile phone, tablet, laptop, or desktop computer. The CMA 106 may be accessed through an app running on the client device or through a website accessed in a browser. The CMA 106 includes an ordering interface 302, which provides an interactive interface with which the customer 104 can browse through and select products and place an order. The ordering interface 302 also may include a selected products list that specifies the amounts and prices of products that the customer 104 has selected to order. The customer 104 may review the selected products list and place an order based on the selected products list. Furthermore, the ordering interface 302 may present recipes to the customer 104 that the online concierge system 102 predicts the customer 104 is attempting to complete, and may provide an option to the customer 104 to add additional products needed to complete a recipe to the customer's selected products list.

Customers 104 may also use the ordering interface 302 to message with pickers 108 and runners 114 and receive notifications regarding the status of their orders. The CMA 106 also includes a system communication interface 304 which, among other functions, receives inventory information from the online concierge system 102 and transmits order and location information to the online concierge system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred retailers 110, preferred handoff times, special instructions for handoff, and so on.

The CMA 106 also includes a location data module 308. The location data module 308 may access and store location data related to a client device associated with a customer 104 via the customer mobile application 106. Location data may include the geographic location of the client device associated with the customer mobile application 106, how fast the client device is travelling, the average speed of the client device when in transit, the direction of travel of the client device, the route the customer 104 is taking to a pickup location, current traffic data near the pickup location, and the like. For simplicity, the location of a customer client device or client device may be referred to as the location of the customer throughout this description. The customer 104 may specify whether or not the share this location data with the customer mobile application 106 via the preferences management interface 306. If a customer 104 does not allow the customer mobile application 106 to access their location data, the location data module 308 may not access any location data for the customer 104. In some embodiments, the customer 104 may specify certain scenarios when the location data module 308 may receive location data, such as when the customer 104 is using the customer mobile application 106, any time, or when the customer 104 turns on location tracking in the customer mobile application 106 via an icon. The customer 104 may also specify which location data the location data module 308 may retrieve, and which location data is off-limits. In some embodiments, the location data module 308 may be tracking the customer's 104 location as a background process while the CMA 106 is in use. In other embodiments, the CMA 106 may use real-time location data from the location data module 308 to display a map to the customer 104 indicating their current location and the route to a pickup location for their order.

FIG. 3B is a block diagram of the picker mobile application (PMA) 112, according to some embodiments. The PMA 112 illustrated in FIG. 3B includes a barcode scanning module 320, a basket manager 322, a system communication interface 324, and an image encoder 326. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The picker 108 accesses the PMA 112 via a mobile client device, such as a mobile phone or tablet. The PMA 112 may be accessed through an app running on the mobile client device or through a website accessed in a browser. The PMA 112 includes a barcode scanning module 320 which allows a picker 108 to scan an item at a retailer 110 (such as a can of soup on the shelf at a grocery store). The barcode scanning module 320 may also include an interface which allows the picker 108 to manually enter information describing an item (such as its serial number, SKU, quantity and/or weight) if a barcode is not available to be scanned. The PMA 112 also includes a basket manager 322 which maintains a running record of items collected by the picker 108 for purchase at a retailer 110. This running record of items is commonly known as a “basket”. In some embodiments, the barcode scanning module 320 transmits information describing each item (such as its cost, quantity, weight, etc.) to the basket manager 322, which updates its basket accordingly. The PMA 112 also includes an image encoder 326 which encodes the contents of a basket into an image. For example, the image encoder 326 may encode a basket of goods (with an identification of each item) into a QR code which can then be scanned by an employee of the retailer 110 at check-out.

The PMA 112 also includes a system communication interface 324, which interacts with the online concierge system 102. For example, the system communication interface 324 receives information from the online concierge system 102 about the items of an order, such as when a customer updates an order to include more or less items. The system communication interface may receive notifications and messages from the online concierge system 102 indicating information about an order. The system communication interface transmits notifications and messages to be displayed via a user interface of the mobile deice associated with the PMA 112.

FIG. 3C is a block diagram of the runner mobile application (RMA) 116, according to some embodiments. The RMA 116 illustrated in FIG. 3C includes a bag interface engine 328, a bag manager 330, and a system communication interface 332. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The runner 114 accesses the RMA 116 via a client device, such as a mobile phone, tablet, laptop, or desktop computer. The RMA 116 may be accessed through an app running on the client device or through a website accessed in a browser. The RMA 116 includes bag interface engine 328, which provides an interactive interface with which the runner 114 can view orders they need to deliver and the locations of the bags for each order, such as on a particular shelf or in a refrigerator of a pickup location. The runner 114 may receive notifications through the bag interface engine 328 about new orders, the location of a customer 104 who is in transit to a pickup location, and new orders to deliver. The runner 114 may also receive communications via the bag interface engine 328 with customers regarding order handoff and pickup confirmation and may interact with the interface generated by the bag interface engine 328 to send communications to customers and the online concierge system 102 regarding order status. For example, a runner 114 may send the customer a pickup spot at the pickup location to meet for order handoff and indicate that an order has been delivered to a customer via the interface, which ends the wait time calculation by the location data module 308 associated with the customer.

The RMA 116 includes a bag manager 330 that manages the assignment of orders to runners 114 and the locations of bags for each order. The RMA 116 also includes a system communication interface 332 which, among other functions, receives inventory information from the online concierge system 102 and transmits order and bag information to the online concierge system 102. The system communication interface may also receive notifications and messages from the online concierge system 102 indicating information about an order. The system communication interface transmits notifications and messages to be displayed via a user interface of the mobile deice associated with the RMA 116.

### Example New Treatment Engine

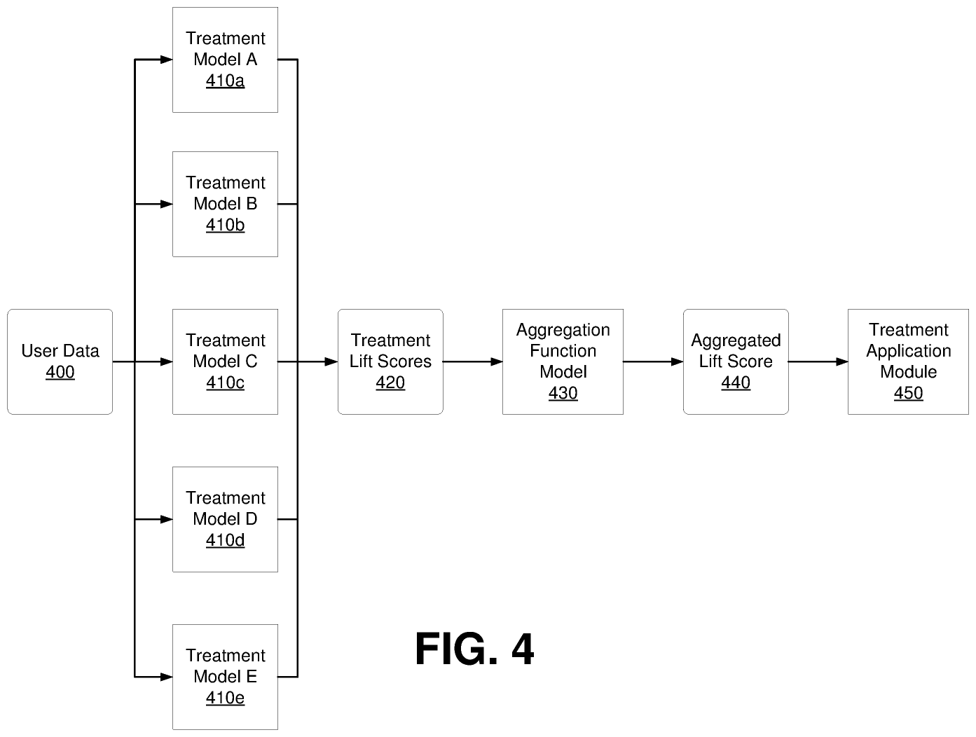

FIG. 4 illustrates a data flow through an example new treatment engine, in accordance with some embodiments. Alternative embodiments may include more, fewer, or different components from those illustrated in FIG. 4, and the functionality of each component may be divided between the components differently from the description below. Additionally, each component may perform their respective functionalities in response to a request from a human, or automatically without human intervention.

The new treatment engine (e.g., new treatment engine 218) receives user data 400 describing characteristics of a user to whom the new treatment engine may apply a treatment. A user may be a customer, a picker, or a runner. The user data 400 may describe a user's interactions with the online concierge system, such as when the user has interacted with the online concierge system, what kinds of interactions the user has had with the online concierge system, how often the user interacts with the online concierge system, or characteristics of the user's interactions with the online concierge system. Additionally, the user data 400 may describe demographic or personal information about the user, such as the user's name, age, gender, sex, income, contact information, location, or residence, if the user has opted to share such information under one or more applicable privacy policies. In some embodiments, the user treatment engine receives user data 400 from a customer database 214, a picker database 212, an inventory database 204, or a transaction records database 208 of the online concierge system.

The new treatment engine applies a set of treatment models 410 to the user data 400. Each treatment model 410 is associated with a type of treatment. A treatment is an action that the online concierge system may take with regards to a user and/or the user's computing device to encourage the user to interact with the online concierge system. A treatment may include a custom-generated message. For example, for a customer user, a treatment may include notifying the user of a new product, sending a message to the user encouraging the user to submit an order, sending a coupon to the user, offering the user a temporary or permanent discount on orders, offering the user a free product, or offering to reduce or eliminate fees on a user's purchase. For a picker user or a runner user, a treatment may include notifying the user of a possible order for servicing, offering the user an additional service fee for servicing an order from another user, offering a temporary or permanent increase in a service fee or commission paid to the user for servicing orders, or offering a reward to the user for servicing a certain number of orders within a time period. A treatment may further include an encouraged interaction for the user to perform. An encouraged interaction is an interaction that is targeted by the online concierge system for the user to perform. For example, an encouraged interaction may be for a user to place an order with the online concierge system or to service an order for the online concierge system.

Each treatment model 410 may be trained to generate a treatment lift score 420 for a particular treatment type. For example, treatment model 410a may be a treatment model 410 that generates treatment lift scores 420 for push notifications with a “We Miss You” message, whereas treatment model 410b may be a treatment model that generates treatment lift scores for push notifications with a “See New Content” message. A treatment type indicates characteristics and parameters for treatments of the treatment type. As the terms are used herein, a treatment may be an instance of a treatment type when applied to a user. A treatment type may be general (e.g., discounts, push notifications, text messages) or may be specific (e.g., a 15% discount on a customer's next order or a push notification with a “We Miss You” message).

Each treatment model 410 is a machine-learning model that is trained to generate a treatment lift score 420 for a treatment type to be applied to a user. A lift score 420 is a score representing a predicted increase in the likelihood that a user will interact with content of the online concierge system in response to applying a treatment of the treatment type to the user.

The set of treatment models 410 depicted in FIG. 4 may be used by other systems within the online concierge system, and may be selected for the new treatment engine based on similarities of the new treatment type to the treatment types associated with the set of treatment models 410. For example, if the new treatment type is a 15% discount on an order through the online concierge system, the set of treatment models 410 may include a treatment model 410 that is associated with a 10% discount treatment type, a treatment model that is associated with a 20% discount treatment type, or even a treatment model 410 that is associated with a fixed $5 discount on orders treatment type. However, the set of treatment models 410 may exclude treatment models 410 associated with treatments that are significantly dissimilar to the new treatment. In the 15% discount example, the set of treatment models 410 might not include a treatment model 410 that is associated with push notifications that notify the user of new items.

Each treatment model 410 may be trained based on a set of training examples. Each training example in the set of training examples may include user data for a user to whom a treatment was applied and whether the user was treated with the treatment. Each training example may also be labeled with whether the user interacted with the online concierge system. Additionally, each treatment model 410 is trained based on a set of training examples associated with a treatment type of the treatment model 410. For example, a treatment model 410 for coupon treatment types is trained based on a set of training examples associated with coupon treatment types, whereas a treatment model 410 for push notifications is trained based on a set of training examples associated with push notification treatment types.

The new treatment engine applies an aggregation function model 430 to the treatment lift scores 420. An aggregation function model 430 is a machine-learning model (e.g., a linear regression, a logistic regression, or a neural network) that is trained to generate aggregated lift scores for a new treatment based on a set of treatment lift scores 420 from the set of treatment models 410. An aggregated lift score 440 is a score that represents a predicted increase in the likelihood that a user will interact with the online concierge system in response to applying the new treatment type to the user. The training process for the aggregation function model 430 is described in further detail below.

The treatment application module 450 determines whether to apply the new treatment type to the user based on the aggregated lift score 440. The treatment application module 450 may apply a lift score threshold to the aggregated lift score 440 to determine whether to apply the new treatment to the user. If the aggregated lift score 440 exceeds the lift score threshold, the new treatment engine applies the new treatment to the user. If the aggregated lift score 440 does not exceed the lift score threshold, the new treatment engine may apply a different treatment to the user or may apply no treatment to the user.

In some embodiments, the treatment application module 450 ranks a set of users based on aggregated lift scores generated for the set of users. The treatment application module 450 may receive user data for the set of users and may generate aggregated lift scores for the users as described above. The treatment application module 450 may apply a lift score threshold to identify a subset of users to whom a treatment of the new treatment type should be applied. In some embodiments, the treatment application module 450 determines the lift score threshold based on a target percentile of users to whom a treatment of the new treatment type should be applied.

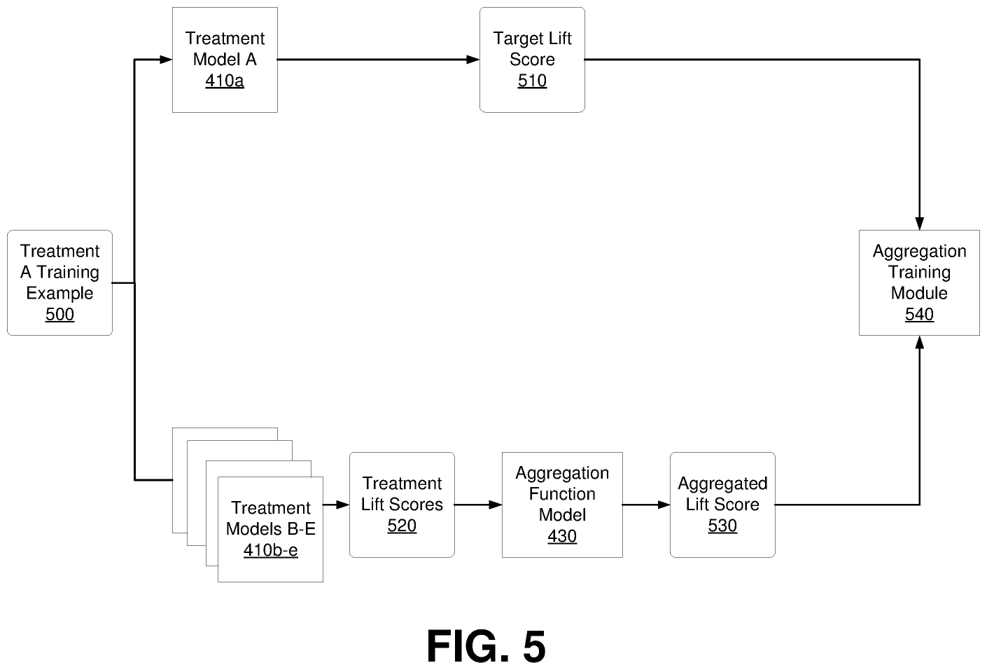

FIG. 5 illustrates a data flow through an example new treatment engine during a training process, in accordance with some embodiments. Alternative embodiments may include more, fewer, or different components from those illustrated in FIG. 5, and the functionality of each component may be divided between the components differently from the description below. Additionally, each component may perform their respective functionalities in response to a request from a human, or automatically without human intervention. FIG. 5 illustrates how a new treatment engine (e.g., new treatment engine 218) may be trained based on a training example 500 that relates to an application of Treatment A. Treatment A, as used herein, is a generic placeholder for any type of treatment.

The new treatment engine (e.g., new treatment engine 218) receives a training example 500 for training the new treatment engine. The training example 500 includes user data describing characteristics of a user. The user may be one to which Treatment A was applied or may be a user to which Treatment A was not applied.

The new treatment engine applies the treatment model 410a for Treatment A to the user data in the training example 500 to generate a target lift score 510 for the training example. The new treatment engine uses the target lift score 510 as a target that the aggregation function model 430 should compute as an aggregated lift score for the user data in the training example.

The new treatment engine applies the treatment models 410b-e to the training example 500 for Treatment A. The treatment models 410b-e generate a set of treatment lift scores 520 for the training example 500, and the new treatment engine applies the aggregation function model 430 to the generated treatment lift scores 520 to generate an aggregated lift score 530 for the training example 500.

The new treatment engine uses the aggregation training module 540 to train the aggregation function model 430 based on the training example 500. For example, the aggregation training module 540 may update one or more weights of the aggregation function model 430 based on the training example 500. To train the aggregation function model 430, the aggregation training module 540 compares the aggregated lift score 530 from the aggregation function model 430 to the target lift score 510 from the treatment model 410a to evaluate the performance of the aggregation function model 430 (e.g., through a loss function). The aggregation training module 540 may update the aggregation function model 430 based on the difference between the aggregated lift score 530 and the target lift score 510. The aggregation training module 540 may apply greater changes to the aggregation function model 430 for a larger difference between the aggregated lift score 530 and the target lift score 510 than for a smaller difference between the scores. For example, the aggregation training module 540 may use a loss function (e.g., least squares) that is based on the difference between the aggregated lift score 530 and the target lift score 510 to update the aggregation function model 430. A larger difference between the aggregated lift score 530 and the target lift score 510 may cause the loss function to apply greater changes to the aggregation function model 430 (e.g., more greatly change one or more weights of the aggregation function model 430) than a smaller difference.

The new treatment engine may apply the process described with regards to FIG. 5 to training examples that correspond to treatments associated with the other treatment models 410. For example, the new treatment engine may perform a similar process with the treatment type that corresponds to treatment model B 410b. In this example, the new treatment engine may receive a training example for Treatment B. The new treatment engine may generate an aggregated lift score 530 by applying the aggregation function model 430 to treatment lift scores 520 that are generated by applying treatment model 410a and treatment models 410c-e to the user data in the Treatment B training example. The new treatment engine may compare the aggregated lift score 530 to a target lift score 510 generated by treatment model B and evaluate the performance of the aggregation function model 430 based on the comparison.

The new treatment engine may apply the training process of FIG. 5 to sets of training examples for each of the treatment models used by the new treatment engine. These sets of training examples may be sets of training examples used by the online concierge system to train the treatment models. The new treatment engine thereby trains the aggregation function model to generate aggregate lift scores that are relevant for treatments that are similar to the treatments associated with the treatment models, such as a new treatment.

By relying on pre-existing treatment models rather than training a new treatment model for a new treatment type, the online concierge system can save storage space by reusing training examples for the pre-existing treatment models, rather than storing new training examples of the new treatment type. Additionally, the online concierge system may be able to use a relatively simple aggregation function model that is based on the outputs of more complex treatment models, thereby saving additional storage space for the online concierge system. Furthermore, by using the aggregation function model as a starting point for a new treatment type, the online concierge system saves computing resources by targeting treatments to users for whom the treatments are more likely to be effective, rather than applying treatments to many users.

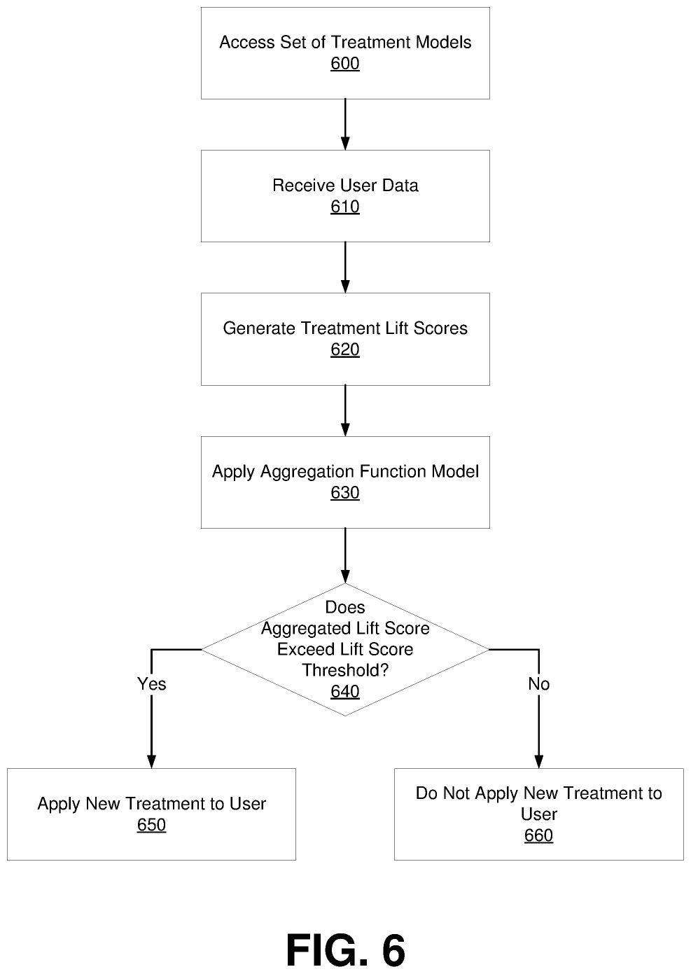

FIG. 6 is a flowchart illustrating a method for generating aggregated lift scores for a new treatment to be applied to a user, in accordance with some embodiments. In alternative embodiments, the method may include more, fewer, or different steps from those illustrated in FIG. 6, or the steps may be performed in a different order from that illustrated. Additionally, each step may be performed with or without human intervention. In some embodiments, the method illustrated in FIG. 6 may be performed by an online concierge system (e.g., online concierge system 102).

An online concierge system (e.g., online concierge system 102) accesses 600 a set of treatment models for a plurality of treatment types. Each treatment model is a machine-learning model that is trained to generate a treatment lift score for a user based on user data describing characteristics of the user. The set of treatment models may include treatment models that are associated with treatment types that are similar to a new treatment type. For example, if the new treatment type is a 15% discount on an order through the online concierge system, then the treatment types of the treatment models in the set of treatment models may be discounts of different magnitudes (e.g., 5%, 10%, 20%).

The online concierge system receives 610 user data describing characteristics of a user of the online concierge system and generates 620 a set of lift scores by applying the set of treatment models to the received user data. For example, in generating the set of lift scores, the online concierge system may apply each of the treatment models to the received user data to generate a lift score from the treatment model, and may associate each lift score with the corresponding treatment model that generated the lift score. The online concierge system applies 630 an aggregation function model to the set of lift scores to generate an aggregated lift score for the user. The aggregation function model is a machine-learning model that is trained to aggregate treatment lift scores and to generate an aggregated lift score that may represent an increase in the likelihood that the user will interact with the online concierge system in response to applying the new treatment type to the user.

The online concierge system determines 640 whether the aggregated lift score exceeds a lift score threshold. The lift score threshold may be a threshold that the online concierge system uses to determine whether to apply a treatment of the new treatment type to the user. The lift score threshold may be a threshold that is pre-determined by a human operator of the online concierge system, or may be a threshold that is adjusted by the online concierge system over time. The lift score threshold may be a threshold score or may be based on a percentile of aggregated lift scores generated by the aggregation function model. In some embodiments, the lift score threshold is set based on a machine-learning model that is trained to set a lift score threshold based on a set of training examples.

If the aggregated lift score exceeds the lift score threshold, the online concierge system applies 650 a treatment of the new treatment type to the user. For example, in applying the treatment, the online concierge system may transmit a custom-generated message to a client device of the user. Similarly, the online concierge system may transmit instructions to user application operating on the client device to display content to the user on the client device. If the aggregated lift score does not exceed the lift score threshold, the online concierge system does not apply 660 a treatment of the new treatment type to the user.

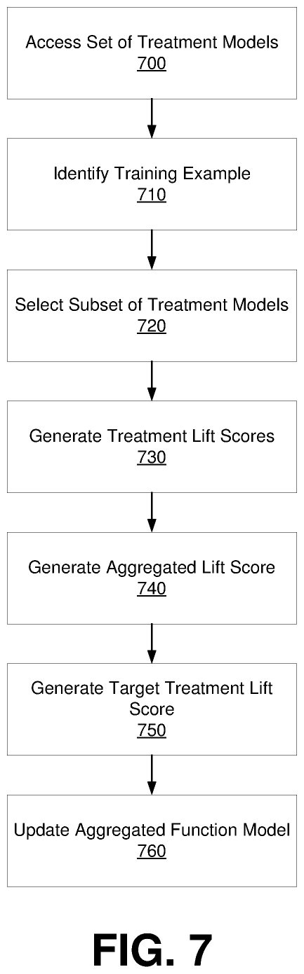

FIG. 7 is a flowchart illustrating a method for training an aggregation function model, in accordance with some embodiments. In alternative embodiments, the method may include more, fewer, or different steps from those illustrated in FIG. 7, or the steps may be performed in a different order from that illustrated. Additionally, each step may be performed with or without human intervention. In some embodiments, the method illustrated in FIG. 7 may be performed by an online concierge system (e.g., online concierge system 102).

The online concierge system (e.g., online concierge system 102) accesses 700 a set of treatment models for a plurality of treatment types. Each treatment model is a machine-learning model that is trained to generate a treatment lift score for a user based on user data describing characteristics of the user. The set of treatment models may include treatment models that are associated with treatment types that are similar to a new treatment type. For example, if the new treatment type is a 15% discount on an order through the online concierge system, then the treatment types of the treatment models in the set of treatment models may be discounts of different magnitudes (e.g., 5%, 10%, 20%).

The online concierge system trains an aggregation function model to generate aggregated lift scores for the new treatment type. To train the aggregation function model, the online concierge system identifies 710 a training example associated with a treatment type of the plurality of treatment types. For example, the online concierge system may identify the training example based on an identifier indicating the treatment type of the treatment of the training example. The training example may include user data describing characteristics of a user to whom a treatment of the treatment type was applied. The online concierge system selects 720 a subset of the set of treatment models. In selecting the subset of the set of treatment models, the online concierge system may select treatment models that are not associated with the treatment type of the training example. For example, if the treatment type of the training example is a 5% discount, the online concierge system may select treatment models that are associated with a 10% discount and a 20% discount. The online concierge system generates 730 treatment lift scores by applying the subset of treatment models to user data included in the training example. For example, in applying the subset of treatment models to the user data included in the training example, the online concierge system may extract features from the user data and input the features into each of the subset of treatment models to generate the treatment lift scores. In some embodiments, the subset of treatment models does not include the treatment model that is associated with the treatment type of the identified training example. The online concierge system generates 740 an aggregated lift score based on the generated treatment lift scores. For example, in generating the aggregated lift score, the online concierge system may apply the aggregation function model to the generated treatment lift scores.

The online concierge system generates 750 a target lift score for the training example by applying the treatment model of the treatment type associated with the training example to the user data of the training example. The online concierge system updates 760 the aggregation function model based on a difference between the aggregated lift score and the target lift score (e.g., by updating one or more weights of the aggregation function model). For example, the online concierge system may apply a loss function that compares the aggregated lift score and the target lift score to evaluate the performance of the aggregation function model.

The online concierge system may repeat steps 730-760 for each training example in a set of training examples associated with a particular treatment type. The online concierge system also may repeat steps 710-760 for each of a plurality of treatment types, thereby training the aggregated function model based on training examples for different treatment types.

### OTHER CONSIDERATIONS

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
at a computer system comprising a processor and a non-transitory memory:
accessing a plurality of treatment models for a plurality of treatment types, wherein each treatment model in the plurality of treatment models is associated with a treatment type of the plurality of treatment types, wherein each treatment model in the plurality of treatment models comprises a machine-learning model trained to generate a treatment lift score for a user based on user data describing characteristics of the user, and wherein each treatment lift score represents an increase in a likelihood that the user corresponding to the treatment lift score will interact with content of an online system in response to receiving a treatment corresponding to the treatment type associated with the treatment lift score;
receiving user data describing characteristics of a first user of the online system;
generating an aggregated lift score for the first user, wherein the aggregated lift score corresponds to a new treatment type that is not in the plurality of treatment types, and wherein the aggregated lift score is generated by:
generating a plurality of treatment lift scores by applying each treatment model of the plurality of treatment models to the user data describing the characteristics of the first user of the online system; and
applying an aggregation function model to the plurality of treatment lift scores, wherein the aggregation function model comprises a machine-learning model trained to aggregate treatment lift scores generated by the plurality of treatment models to compute aggregated lift scores for new treatment types; and
determining whether the aggregated lift score exceeds a lift score threshold;
responsive to determining that the aggregated lift score exceeds the lift score threshold, applying a treatment of the new treatment type to the first user.

2. The method of claim 1, wherein applying the treatment of the new treatment type to the first user comprises:
ranking a set of users based on aggregated lift scores generated for the set of users;
identifying a subset of the set of users associated with aggregated lift scores that exceed the lift score threshold; and
applying a treatment of the new treatment type to the subset of users.

3. The method of claim 2, wherein the lift score threshold is determined based on a target percentile of users to whom a treatment of the new treatment type should be applied.

4. The method of claim 1, further comprising:
receiving second user data describing characteristics of a second user;
applying a treatment model of the plurality of treatment models to the second user data to generate a treatment lift score for the second user; and
applying a treatment to the second user based on the treatment lift score, wherein the treatment is of a treatment type associated with the treatment model.

5. The method of claim 1, wherein the aggregation function model comprises a linear regression.

6. The method of claim 1, wherein the aggregation function model comprises a logistic regression.

7. The method of claim 1, wherein the aggregation function model comprises a neural network.

8. The method of claim 1, wherein the new treatment type comprises a custom-generated message.

9. The method of claim 1, wherein the new treatment type comprises a promotion of an item on the online concierge system.

10. The method of claim 1, further comprising:
responsive to determining that the aggregated lift score does not exceed the lift score threshold, applying a treatment of a treatment type of the plurality of treatment types to the user.

11. A method comprising:
at a computer system comprising a processor and a non-transitory memory:
accessing a set of treatment models for a set of treatment types, wherein each treatment model in the set of treatment models is associated with a treatment type of the set of treatment types, wherein each treatment model in the set of treatment models comprises a machine-learning model trained to generate a treatment lift score for a user of an online concierge system based on user data describing characteristics of the user; and wherein each treatment lift score represents an increase in a likelihood that the user corresponding to the treatment lift score will interact with content of the online concierge system in response to receiving a treatment corresponding to the treatment type associated with the treatment lift score; and
training an aggregation function model to generate aggregated lift scores for new treatment types based on a set of treatment lift scores, wherein training the aggregation function model comprises:
for each treatment type of the set of treatment types:
identifying a training example associated with the treatment type, wherein the training example comprises user data describing characteristics of a user;
selecting a subset of treatment models from the set of treatment models, wherein selecting the subset of treatment models comprises excluding the treatment model of the set of treatment models associated with the treatment type; and
generating a target lift score by applying the treatment model of the set of treatment models associated with the treatment type to the user data of the training example;
generating a set of treatment lift scores by applying each treatment model of the subset of treatment models to the user data of the training example;
generating an aggregated lift score by applying the aggregation function model to the generated set of treatment lift scores; and
updating the aggregation function model based on a difference between the target lift score and the aggregated lift score.

12. The method of claim 11, wherein the aggregation function model comprises a logistic regression.

13. The method of claim 11, wherein the aggregation function model comprises a neural network.

14. The method of claim 11, wherein the identified training example is a training example used to train the treatment model of the set of treatment models associated with the treatment type.

15. The method of claim 11, wherein the identified training example comprises user data describing characteristics of a user to whom a treatment of the treatment type was applied.

16. The method of claim 11, wherein the identified training example comprises user data describing characteristics of a user to whom a treatment of the treatment type was not applied.

17. The method of claim 11, further comprising:
for each treatment type of the set of treatment types:
identifying a set of training examples associated with the training type; and
updating the aggregation function model based on each training example in the identified set of training examples by comparing a target lift score for each training example with an aggregated lift score for each training example.

18. The method of claim 11, further comprising:
receiving user data describing characteristics for a user;
generating a set of treatment lift scores by applying the set of treatment models to the user data;
generating an aggregated lift score for the user by applying the aggregation function model to the set of treatment lift scores; and
applying a treatment of a new treatment type to the user based on the aggregated lift score.

19. The method of claim 11, wherein updating the aggregation function model comprises:
applying a loss function to the target lift score and the aggregated lift score.

20. A non-transitory computer-readable medium storing instructions that, when executed by a processor, cause the processor to:
access a plurality of treatment models for a plurality of treatment types, wherein each treatment model in the plurality of treatment models is associated with a treatment type of the plurality of treatment types, wherein each treatment model in the plurality of treatment models comprises a machine-learning model trained to generate a treatment lift score for a user based on user data describing characteristics of the user, and wherein each treatment lift score represents an increase in a likelihood that the user corresponding to the treatment lift score will interact with content of an online system in response to receiving a treatment corresponding to the treatment type associated with the treatment lift score;
receive user data describing characteristics of a first user of the online system;
generate an aggregated lift score for the first user, wherein the aggregated lift score corresponds to a new treatment type that is not in the plurality of treatment types, and wherein the aggregated lift score is generated by:
generating a plurality of treatment lift scores by applying each treatment model of the plurality of treatment models to the user data describing the characteristics of the first user of the online system; and
applying an aggregation function model to the plurality of treatment lift scores, wherein the aggregation function model comprises a machine-learning model trained to aggregate treatment lift scores generated by the plurality of treatment models to compute aggregated lift scores for new treatment types; and
determine whether the aggregated lift score exceeds a lift score threshold;
responsive to determining that the aggregated lift score exceeds the lift score threshold, apply a treatment of the new treatment type to the first user.
